(19) United States
(12) Patent Application Publication
(10) Pub. No.: US 2026/0238990 A1
(43) Pub. Date: Aug. 13, 2026

(54) RADIO BASE STATION AND RADIO COMMUNICATION METHOD

(71) Applicant: NTT DOCOMO, INC., Tokyo (JP)

(72) Inventor: Tianyang MIN, Tokyo (JP)

(73) Assignee: NTT DOCOMO, INC., Tokyo (JP)

(21) Appl. No.: 19/153,359

(22) PCT Filed: Feb. 14, 2023
(86) PCT No.: PCT/JP2023/005034

§ 371 Date: Aug. 4, 2025

(51) Int. Cl. H04W 8/24; H04W 24/08; H04W 24/10

(52) U.S. Cl. CPC H04W 8/24; H04W 24/08; H04W 24/10

(57) ABSTRACT

A radio base station includes a first device and a second device. The first device receives, from the second device, a transmission configuration indication of the second device, and performs control in such a manner that the transmission configuration indication is transmitted to a terminal via the second device.

### TECHNICAL FIELD

The present disclosure relates to a radio base station and a radio communication method supporting L1/L2 mobility.

### BACKGROUND ART

The 3rd Generation Partnership Project (3GPP, registered trademark) has prepared a specification for the 5th generation mobile communication system (also called 5G, New Radio (NR), or Next Generation (NG) ) and is also preparing next generation specifications called Beyond 5G, 5G Evolution, or 6G.

For example, enhancement of layer 1/layer 2 mobility (L1/L2 mobility) is discussed in 3GPP Release 18. L1/L2 mobility, which is also called Lower layer Triggered Mobility (LTM), is a technology related to mobility of a terminal (User Equipment, UE) in layer 1 or layer 2, and includes UE transition to another cell, etc. (handover (HO)) (Non-Patent Document 1). An HO using L1/L2 mobility is realized by a lower layer, such as a medium access control layer (MAC).

It is also considered to support L1/L2 mobility between a CU (Central Unit) and a DU (Distributed Unit) of a radio base station (gNB).

### CITATION LIST

### Non-Patent Literature

Non-Patent Literature 1: “Further NR Mobility Enhancements”, RP-222332, 3GPP TSG RAN Meeting #97-e, 3GPP, September 2022

### SUMMARY OF INVENTION

However, when supporting L1/L2 mobility between a CU and a DU, the following issues are considered. Specifically, in order for UE to perform an HO directly to a beam of a target cell of an HO destination, the UE should recognize L1 measurement RS config and Transmission Configuration Indication state (TCI state) of the beam level, but cannot recognize L1 measurement RS config and TCI state in a target-side DU.

Furthermore, L1 measurement report config is configured by a source-side DU of an HO source, and L1 measurement RS config is configured by a target-side DU. UE needs both L1 measurement report config and L1 measurement RS config to perform an HO, but cannot be timely provided with both the L1 measurement report config and the L1 measurement RS config at HO time.

Therefore, the following disclosure has been made in view of this situation, and an object of the present disclosure is to provide a radio base station and a radio communication method capable of reliably and timely providing UE with a configuration necessary for handover when supporting L1/L2 mobility between a CU and a DU.

One aspect of the disclosure is a radio base station (gNB 100) including: a first device; and a second device, wherein the first device includes: a reception unit (radio communication unit 110) that receives, from the second device, a transmission configuration indication of the second device; and a control unit (control unit 140) that performs control in such a manner that the transmission configuration indication is transmitted to a terminal via the second device.

One aspect of the disclosure is a radio base station including: a first device; and a second device, wherein the first device includes: a reception unit that receives, from the second device, a reference signal configuration for measurement of the second device; and a control unit that performs control in such a manner that the reference signal configuration is transmitted to a terminal via the second device.

One aspect of the disclosure is a radio base station (gNB 100) including: a first device; and a second device, wherein the first device includes: a reception unit (radio communication unit 110) that receives a measurement report configuration of the second device on a source side, and a reference signal configuration for measurement of the second device on a target side; and a control unit (control unit 140) that combines the measurement report configuration and the reference signal configuration and performs control in such a manner that the combined measurement report configuration and reference signal configuration is transmitted to a terminal via the second device on the source side.

One aspect of the disclosure is a radio base station (gNB 100) including: a first device; and a second device, wherein the second device on a source side includes: a reception unit (radio communication unit 110) that receives a reference signal configuration of the second device on a target side via the first device; and a control unit (control unit 140) that combines a measurement report configuration of the second device on the source side, and the received reference signal configuration, and performs control in such a manner that the combined measurement report configuration and reference signal configuration are transmitted to a terminal via the first device.

One aspect of the disclosure is a radio base station (gNB 100) including: a first device; and a second device, wherein the first device includes: a reception unit (radio communication unit 110) that receives a measurement report configuration of the second device on a source side, and a reference signal configuration for measurement of the second device and a transmission configuration indication on a target side; and a control unit (control unit 140) that combines the measurement report configuration and the reference signal configuration and performs control in such a manner that the combined measurement report configuration and reference signal configuration, and the transmission configuration indication are transmitted to a terminal via the second device on the source side.

One aspect of the disclosure is a radio base station (gNB 100) including: a first device; and a second device, wherein the second device on a source side includes: a reception unit (radio communication unit 110) that receives a reference signal configuration of the second device on a target side via the first device; and a transmission unit (radio communication unit 110) that transmits, to a terminal, a measurement report configuration and a reference signal configuration in which the measurement report configuration in the second device on the source side and the reference signal configuration are combined, and a transmission configuration indication of the second device on the target side.

One aspect of the disclosure is a radio base station (gNB 100) including: a first device; and a second device, wherein the first device includes: a reception unit (radio communication unit 110) that receives resource information indicating an uplink resource for measurement reporting from the second device on a target side; and a transmission unit that transmits the resource information to the second device on a source side, in which the second device on the source side includes a transmission unit (radio communication unit 110) that transmits the resource information to a terminal.

One aspect of the disclosure is a radio base station (gNB 100) including: a first device; and a second device, wherein the first device includes: a reception unit (radio communication unit 110) that receives resource information indicating an uplink resource for measurement reporting from the radio base station on a target side; and a transmission unit (radio communication unit 110) that transmits the resource information to the radio base station on the target side.

### BRIEF DESCRIPTION OF DRAWINGS

FIG. 1 is an overall schematic configuration diagram of a radio communication system 10.

FIG. 2 is a diagram illustrating an example of control using L1/L2 Mobility.

FIG. 3 is a functional block diagram of a gNB 100.

FIG. 4 is a functional block diagram of UE 200.

FIG. 5 is a diagram illustrating a sequence example of L1/L2 Mobility according to operation example 1.

FIG. 6 is a diagram illustrating a sequence example of L1/L2 Mobility according to operation example 2 (option 1).

FIG. 7 is a diagram illustrating a sequence example of L1/L2 Mobility according to operation example 2 (option 2).

FIG. 8 is a diagram illustrating a sequence example of L1/L2 Mobility according to operation example 3 (option 1).

FIG. 9 is a diagram illustrating a sequence example of L1/L2 Mobility according to operation example 3 (option 2).

FIG. 10 is a diagram illustrating a sequence example of L1/L2 Mobility according to operation example 4.

FIG. 11 is a diagram illustrating a configuration example of TCI state.

FIG. 12 is a diagram illustrating a configuration example of L1 measurement RS config.

FIG. 13 is a diagram illustrating a configuration example of L1 measurement report config.

FIG. 14 illustrates an example of a hardware configuration of the gNB 100 and the UE 200.

FIG. 15 illustrates a configuration example of a vehicle 2001.

### DESCRIPTION OF EMBODIMENTS

An embodiment will be described below with reference to the drawings. Note that the same or similar reference numerals have been attached to the same functions and configurations, and the description thereof is omitted as appropriate.

### (1) Overall Schematic Configuration of Radio Communication System

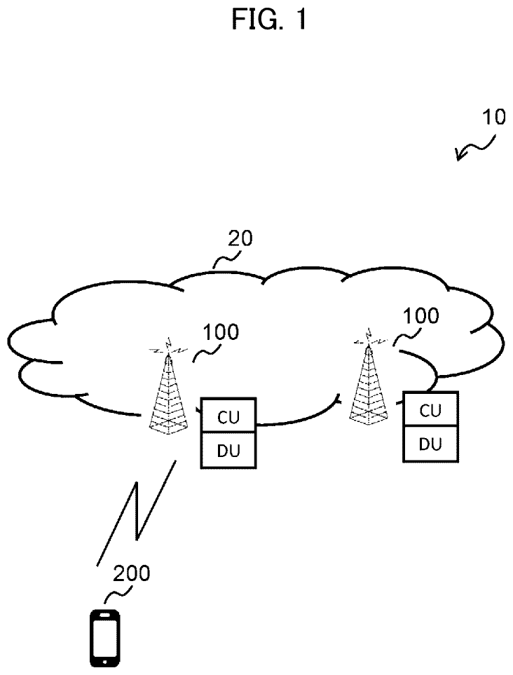

FIG. 1 is an overall schematic configuration diagram of a radio communication system 10 according to the present embodiment. The radio communication system 10 is a 5G New Radio (NR) compliant radio communication system and includes a Next Generation-Radio Access Network 20 (hereinafter, NG-RAN 20) and a terminal 200 (User Equipment 200, hereinafter UE 200).

Note that the radio communication system 10 may be compliant with a system called Beyond 5G, 5G Evolution, or 6G, or include a radio communication system compliant with a method called Long Term Evolution (LTE) or 4G. The radio communication system 10 may support functions related to Industrial Internet of Things (IIoT) and URLLC (Ultra-Reliable and Low Latency Communications).

The NG-RAN 20 includes the radio base station 100 (hereinafter, gNB 100). Note that the specific configuration of the radio communication system 10, including the number of gNBs (or eNBs, etc.) and UEs, is not limited to the example illustrated in FIG. 1.

Furthermore, the gNB 100 may adopt a fronthaul (FH) interface specified by O-RAN (Open Radio Access Network Alliance). The gNB 100 may include O-DU (O-RAN Distributed Unit) and O-RU (O-RAN Radio Unit). The gNB 100 can function as a kind of NG-RAN node.

The NG-RAN 20 actually includes multiple NG-RAN Nodes, specifically gNBs (or ng-eNBs), and is connected to a 5G-compliant core network (5GC, not illustrated). Note that the NG-RAN 20 and 5GC may be expressed simply as a “network”. The 5GC may introduce the concept of CUPS (Control and User Plane Separation) where functions of a user plane and a control plane are clearly separated.

The gNB 100 is an NR-complaint radio base station and performs radio communication with the UE 200 according to NR. Note that the gNB 100 may include a CU (Central Unit, first unit) and a DU (Distributed Unit, second unit), and the DU may be separated from the CU and may be installed at a different geographic location. One or more DUs may be connected to the CU. The gNBs 100 (gNB-CU) may be connected by an Xn interface, and the CU and the DU may be connected by an F1 interface (such as F1-AP).

The gNB 100 and the UE 200 can support Massive MIMO (multiple-input multiple-output) generating a beam with higher directivity by controlling radio signals transmitted from multiple antenna elements, a carrier aggregation (CA) bundling and using multiple component carriers (CCs), and dual connectivity (DC) performing simultaneous communication between UE and each of multiple NG-RAN Nodes.

In the radio communication system 10, not only mobility control of the UE 200 at layer 3 (which may be called L3 Mobility), but also mobility control at layer 1 and/or layer 2 (which may be called L1/L2 Mobility or LTM) may be applied. L3 Mobility may be interpreted as mobility control at a radio resource control (RRC) layer. In contrast, L1/L2 Mobility may be interpreted as mobility control at a physical (PHY) layer, a medium access control (MAC) layer, a radio link control (RLC) layer, and a packet data convergence protocol (PDCP) layer.

Mobility of UE 200 may mean ease of movement and maneuverability of the UE 200 in a broad sense, but in the present embodiment, it may mean minimization of call drops, radio link (including beam) failures, unnecessary handovers, ping-pong conditions, and the like.

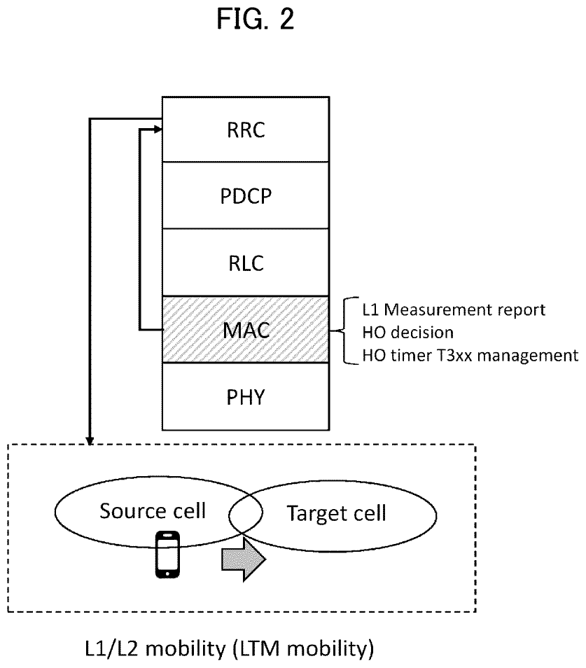

FIG. 2 illustrates an example of control using L1/L2 Mobility. As illustrated in FIG. 2, not RRC included in layer 3, but MAC included in a lower layer (layer 1/layer 2) can perform measurement report, handover (HO) determination from a source cell to a target cell (candidate may be included), and timer (T3xx is used here for convenience) management for determining HO success or failure. T3xx may be interpreted as a timer configured for the same purpose as a timer T304 in L3, that is, a timer used for determining HO (cell transition) success or failure.

MAC may report information on measurement report, HO determination, and T3xx to an upper (RRC) layer. RRC may manage a state of a radio resource associated with cell transition of the UE 200, based on the report.

In the present embodiment, a channel includes a control channel and a data channel. The control channel includes a PDCCH (Physical Downlink Control Channel), a PUCCH (Physical Uplink Control Channel), a PRACH (Physical Random Access Channel), and a PBCH (Physical Broadcast Channel), etc.

The data channel includes a PDSCH (Physical Downlink Shared Channel) and a PUSCH (Physical Uplink Shared Channel), etc.

Note that a reference signal includes a Demodulation reference signal (DMRS), a Sounding Reference Signal (SRS), a Phase Tracking Reference Signal (PTRS), and a Channel State Information-Reference Signal (CSI-RS), etc, and a signal includes the channel and the reference signal. Data may mean one transmitted via the data channel.

### (2) Functional Block Configuration of Radio Communication System

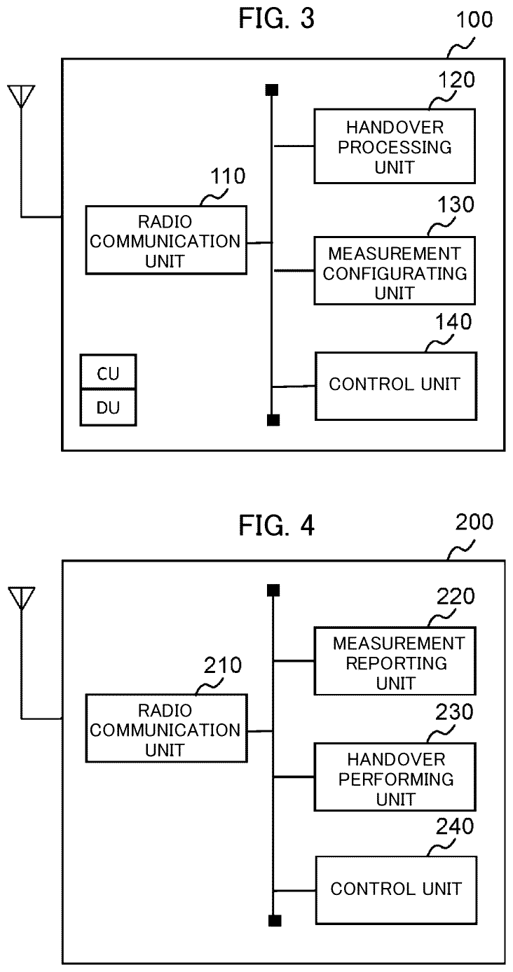

Next, a functional block configuration of the radio communication system 10 will be described. Specifically, the functional block configurations of the gNB 100 and the UE 200 will be described. FIG. 3 is a functional block configuration diagram of the gNB 100. FIG. 4 is a functional block diagram of the UE 200.

### (2.1) gNB 100

As illustrated in FIG. 3, the gNB 100 includes a radio communication unit 110, a handover processing unit 120, a measurement configurating unit 130, and a control unit 140.

The radio communication unit 110 transmits a downlink signal (DL signal) according to NR. The radio communication unit 110 receives an uplink signal (UL signal) according to NR.

In the case of a CU (first device) of the gNB 100, the radio communication unit 110 may receive Transmission Configuration Indication State (TCI state) in a target-side DU (second device) from the DU. In the present embodiment, the radio communication unit 110 may include a reception unit. Note that TCI state (transmission configuration indication) of the DU need not be received directly from the DU, but may be received via a source-side DU and/or the UE 200.

The TCI state may provide information on an antenna port that is arranged at substantially the same location (quasi-collocated: QCL) as an antenna port of a PDCCH. When the UE 200 has a specific CORESET (control resource set) that is spatially arranged at the same location as a specific CSI-RS, the UE 200 can determine which beam is proper when receiving a PDCCH using the CORESET. Note that QCL/TCI state/beam may be read interchangeably.

In the case of a CU of the gNB 100, the radio communication unit 110 may receive a reference signal configuration for measurement in a target-side DU, specifically, L1 measurement RS config, from the DU. Note that the L1 measurement RS config of the DU need not be received directly from the DU, but may be received via a source-side DU and/or the UE 200.

The L1 measurement RS config may indicate configuration of a reference signal (RS) for the UE 200 to perform measurement in a lower layer. Note that a configuration example of the TCI state and L1 measurement RS config will be described below.

Alternatively, in the case of a CU of the gNB 100, the radio communication unit 110 may receive L1 measurement report config (measurement report configuration) in a source-side DU, and L1 measurement RS config in a target-side DU.

The L1 measurement report config may indicate a configuration for the UE 200 to perform measurement report in a lower layer. Note that a configuration example of the L1 measurement report config will be described below.

Alternatively, in the case of a CU of the gNB 100, the radio communication unit 110 may receive L1 measurement report config in a source-side DU, and L1 measurement RS config and TCI state in a target-side DU.

In the case of a CU of the gNB 100, the radio communication unit 110 may receive resource information indicating an uplink resource for a measurement report from a target-side DU. The uplink resource (UL resource) may be used for the measurement report by the UE 200. The radio communication unit 110 may transmit the received resource information to a source-side DU. In the present embodiment, the radio communication unit 110 may include a transmission unit.

Alternatively, the radio communication unit 110 may receive the resource information from a target-side gNB 100 and transmit the resource information to the target-side gNB 100 (may mean CU or may mean Inter-CU HO).

In the case of a source-side DU or a target-side DU of the gNB 100, the radio communication unit 110 may transmit the resource information to the UE 200.

In the case of a source-side DU of the gNB 100, the radio communication unit 110 may receive L1 measurement RS config in a target-side DU via the CU. Furthermore, the radio communication unit 110 may transmit L1 measurement report config and L1 measurement RS config in which L1 measurement report config in the source-side DU and the received L1 measurement RS config are combined, and TCI state in the target-side DU to the UE 200.

The handover processing unit 120 performs handover of the UE 200. Specifically, the handover processing unit 120 performs handover from a serving cell of the UE 200 to a neighbor cell.

Note that the serving cell may be interpreted simply as a cell to which the UE 200 is connected. More specifically, in the case of an RRC_CONNECTED UE without a carrier aggregation (CA) configured, only one serving cell forms a primary cell. In the case of an RRC_CONNECTED UE configured with a CA, the serving cell may be interpreted as representing a set of one or more cells including a primary cell and all secondary cells.

The handover may also include a Conditional Handover (CHO) and/or a dual active protocol stack (DAPS) handover.

The CHO can perform a UE 200 driven handover when a specific execution condition is satisfied. If the CHO is not applicable, a normal handover may be performed (also called CHO recovery). In CHO recovery, the UE 200 performs a cell selection after CHO failure, but if a CHO candidate cell is selected, conditional RRCRReconfiguration of that cell can be directly applied and reconnected without transmitting an RRCRRestablementRequest to a candidate target cell.

The execution condition may consist of one or two trigger conditions (CHO event A 3/A5 specified in 3GPP TS 38.331). A single reference signal (RS) type may be triggered, and up to two different trigger quantities (for example, Reference Signal Received Power (RSRP) and Reference Signal Received Quality (RSRQ), RSRP and Signal-to-Interference plus Noise power Ratio (SINR), or the like) may be simultaneously configured for evaluation of CHO execution condition of a single candidate cell.

The measurement configuring unit 130 performs configuration (measurement configuration) of quality measurement of a serving cell and a neighbor cell by the UE 200. Specifically, the measurement configuring unit 130 may perform the measurement configuration in layer 3, or may perform the measurement configuration in layer 1 and/or layer 2.

The measurement configuring unit 130 can notify the UE 200 of the content of measurement configuration. The UE 200 may measure quality of a serving cell and/or a neighbor cell, based on the notified measurement configuration. The measurement configuring unit 130 can receive a measurement report indicating the measurement result of the cell quality from the UE 200.

The control unit 140 controls each functional block configuring the gNB 100. In particular, in the present embodiment, the control unit 140 can perform control as a CU (source-side or target-side) or a DU (source-side or target-side) in the gNB 100 having a CU-DU configuration.

Specifically, in the case of a source-side CU of the gNB 100, the control unit 140 can perform control in such a manner that TCI state is transmitted via a source-side DU to the UE 200. More specifically, the control unit 140 can cause an RRC layer message including TCI state acquired from a target-side DU to be transmitted to the source-side DU via the radio communication unit 110, and can cause the RRC layer message including the TCI state to be transmitted from the source DU to the UE 200. Note that the TCI state may be transmitted from the target-side DU to the UE 200 instead of the source-side DU.

In the case of a source-side CU of the gNB 100, the control unit 140 can also perform control in such a manner that L1 measurement RS config is transmitted to the UE 200 via the source-side DU. Specifically, in a similar manner to TCI state, the control unit 140 can cause an RRC layer message including the L1 measurement RS config acquired from the target-side DU to be transmitted to the source-side DU via the radio communication unit 110, and can cause the RRC layer message including the L1 measurement RS config to be transmitted from the source DU to the UE 200. Note that the L1 measurement RS config may be transmitted to the UE 200 from the target-side DU instead of the source-side DU.

Alternatively, in the case of a source-side CU of the gNB 100, the control unit 140 may perform control in such a manner that L1 measurement report config and L1 measurement RS config acquired from a DU are combined, and the combined L1 measurement report config and L1 measurement RS config are transmitted to the UE 200 via a source-side DU. Specifically, the control unit 140 can cause an RRC layer message including the combined L1 measurement report config and L1 measurement RS config to be transmitted to a source DU via the radio communication unit 110, and can cause the RRC layer message including the combined L1 measurement report config and the L1 measurement RS config to be transmitted from the source DU to the UE 200.

In the case of a source-side DU of the gNB 100, the control unit 140 can also perform control in such a manner that L1 measurement report config in a source-side DU and the received L1 measurement RS config are combined, and the combined L1 measurement report config and L1 measurement RS config are transmitted to the UE 200 via a source-side CU.

Specifically, the control unit 140 can cause an RRC layer message including the combined L1 measurement report config and L1 measurement RS config to be transmitted to a source CU via the radio communication unit 110, and can cause the RRC layer message including the combined L1 measurement report config and L1 measurement RS config to be transmitted from the source CU to the UE 200. Note that the RRC layer message including the combined L1 measurement report config and L1 measurement RS config may be transmitted to the UE 200 from a target-side CU instead of the source-side CU.

In the case of a source-side CU of the gNB 100, the control unit 140 may combine the obtained L1 measurement report config and L1 measurement RS config, and perform control in such a manner that the combined L1 measurement report config and L1 measurement RS config, and TCI state, are transmitted to the UE 200 via the source-side DU.

Specifically, the control unit 140 can combine L1 measurement report config and L1 measurement RS config, cause an RRC layer message including the combined L1 measurement report config and L1 measurement RS config, and TCI state, to be transmitted to a source DU via the radio communication unit 110, and cause the RRC layer message including the combined L1 measurement report config and L1 measurement RS config, and the TCI state, to be transmitted from the source DU to the UE 200.

Note that a specific example of a sequence between a CU and a D will be described below.

### (2.2) UE 200

As illustrated in FIG. 4, the UE 200 includes a radio communication unit 210, a measurement reporting unit 220, a handover performing unit 230, and a control unit 240.

The radio communication unit 210 transmits an uplink signal (UL signal) according to NR. The radio communication unit 210 receives an uplink signal (DL signal) according to NR.

The measurement reporting unit 220 can measure quality of a serving cell of the UE 200 and a neighbor cell of the serving cell and report the measurement result (Measurement Report) to a network. The measurement reporting unit 220 may perform measurement report of a source cell and a target cell at handover.

The quality of a measurement object may be, for example, included in Measurement Report specified in the 3GPP TS 38.331 (for example, Reference Signal Received Power (RSRP), Reference Signal Received Quality (RSRQ), or the like).

The handover performing unit 230 performs handover of the UE 200. Specifically, the handover performing unit 230 may perform handover to a transition destination cell (NG-RAN node), based on control by the gNB 100.

Also, the handover performing unit 230 can perform processes related to a normal handover (legacy handover), a conditional handover (CHO), and a DAPS handover.

In the case of a CHO, the handover performing unit 230 may transit to a candidate cell when an execution condition is satisfied. As described above, the execution condition may be determined based on quality of a reference signal (RS), specifically, a value of RSRP, RSRQ, or SINR.

The transition destination of the CHO need not be accompanied by an SCG, but may be accompanied by an SCG. In other words, the transition destination cell of the CHO may be a single cell or may include multiple cells (which may be read as a cell group) compliant with DC.

In addition, the handover performing unit 230 may perform handover based on L1/L2 Mobility as well as L3 Mobility. The handover may be read as transition, cell transition, cell selection, or the like. Specifically, the handover performing unit 230 may perform handover based on L1/L2 Mobility, on the basis of at least one command of layer 1 and/or layer 2.

The type of command is not particularly limited and may be an L1/L2 Mobility command, for example. The L1/L2 Mobility command may be read as a command of an RRC layer.

The control unit 240 controls each functional block configuring the UE 200. Specifically, the control unit 240 can perform registration of the UE 200 to the network (waiting for a specific cell), measurement report, and control of handover of the UE 200.

In particular, in the present embodiment, the control unit 240 controls measurement of cells including a serving cell. Specifically, the control unit 240 can control the measurement of a serving cell and a neighbor cell in layer 1 (and/or layer 2). That is, the control unit 240 can perform the measurement of a serving cell and a neighbor cell using a function of layer 1 (and/or layer 2) (which may be called L1 measurement).

When a failure occurs in layer 1 (and/or layer 2), the control unit 240 may notify the terminal RRC of the failure information. Note that the failure information may be provided to a layer other than the RRC (e.g. MAC, RLC, or PDCP). The failure information is not particularly limited but may include identification information (ID) of a source cell (handover source), identification information (ID) of a target cell (handover destination), and/or the quality of the cell (or beam).

Furthermore, the control unit 240 can perform L1/L2 Mobility, that is, mobility control of at least one of layer 1 and layer 2. Mobility control using L1/L2 Mobility may include quality measurement of a service area and a neighbor cell in layer 1 or layer 2, configuration of a fiber destination candidate cell, a cell reselection (transition), and handover.

### (3) Operation of Radio Communication System

Next, operation of the radio communication system 10 will be described. Specifically, operation related to a handover between a CU and a DU using L1/L2 Mobility (LTM) will be described.

Note that L1/L2 Mobility of the UE 200 between DUs under the same CU is called Intra-CU-Inter-DU LTM, and L1/L2 Mobility of UE 200 between DUs of a source-side CU and a target-side CU, which are different, may be called Inter-CU LTM.

### (3.1) Operation Example 1

In Intra-CU/Inter-DU LTM, it is necessary to know L1 measurement RS config and TCI state (may be called TCI state info.) of a beam level of a target cell to realize a direct handover to a beam of a target cell (beam forming a target cell) of the UE 200.

In this operation example, transmission of L1 measurement RS config and TCI state from a target-side DU to a CU is supported on an F1-AP interface.

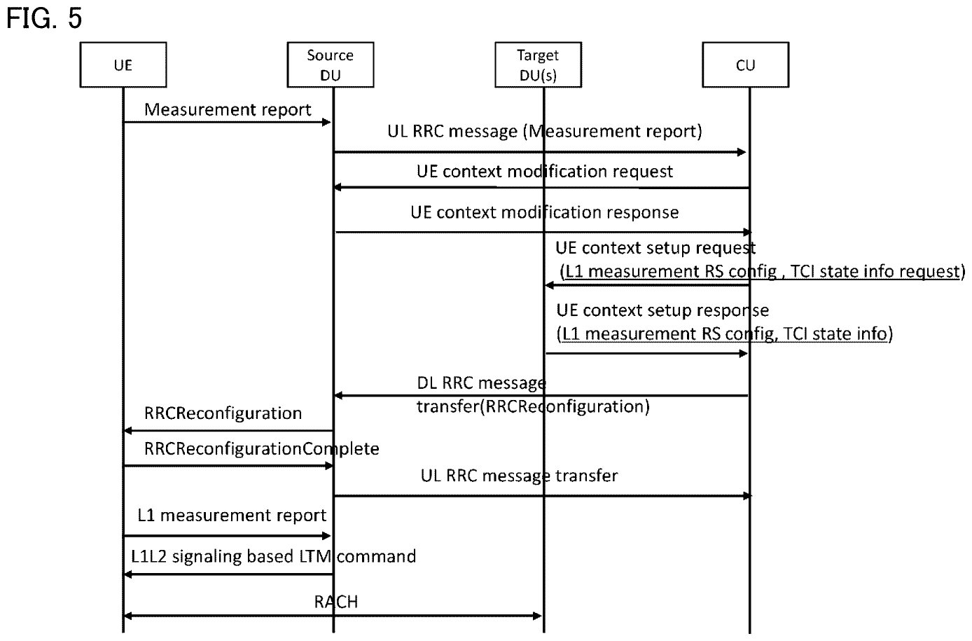

FIG. 5 illustrates a sequence example of L1/L2 Mobility according to operation example 1. As illustrated in FIG. 5, in Intra-CU/Inter-DU LTM, a CU may request a target-side DU that TCI state of the target-side DU (may be LTM indication) is required in F1-AP.

The target-side DU may transmit the TCI state to the CU using a UE context setup response message. Alternatively, the target-side DU may transmit the message including the TCI state in an RRC container (for example, DU to CU RRC Information) to the CU.

The CU may include the TCI state, which is received from the target-side DU, in an RRCReconfiguration message, and transmit a DL RRC message transfer message (may be a UE context modification request message) including the RRCReconfiguration message to a source-side DU.

The source-side DU may transmit RRCReconfiguration including TCI state to the UE 200.

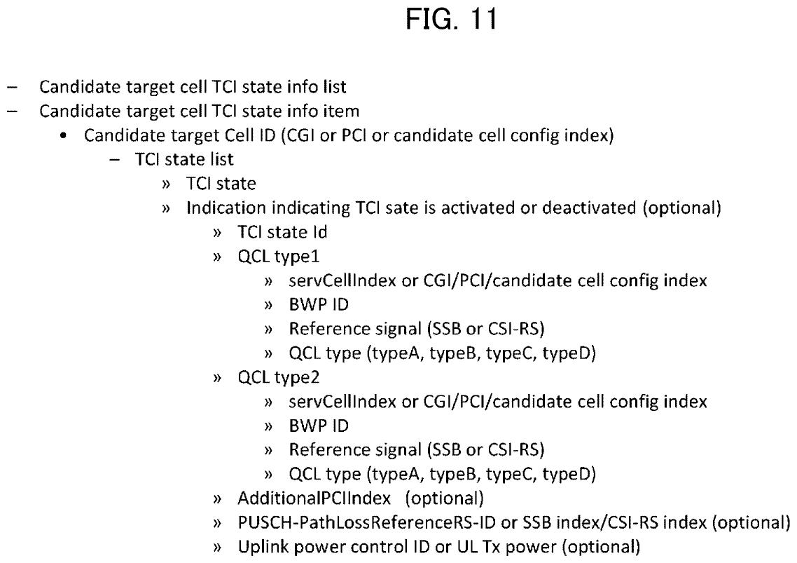

FIG. 11 illustrates a configuration example of TCI state. As illustrated in FIG. 11, CGI (Cell Global Identifier), PCI (Physical Cell ID), or candidate cell config index (configuration index of candidate cell) may be applied as a Candidate target Cell ID. Similarly, CGI, PCI, or a candidate cell config index may be applied also to QCL type.

Furthermore, as illustrated in FIG. 5, in Intra-CU/Inter-DU LTM, the CU may request the target DU that L1 measurement RS config of the target DU (may be LTM indication) is required in F1-AP.

The target DU may transmit the L1 measurement RS config to the CU by using a UE context setup response message. Alternatively, the target DU may transmit the message including the L1 measurement RS config in an RRC container (for example, DU to CU RRC Information) to the CU.

The CU may cause the L1 measurement RS config received from the target DU to be included in an RRCReconfiguration transfer message, and transmit a DL RRC message transfer message (may be a UE context modification request message) including the RRCRReconfiguration message to the source-side DU.

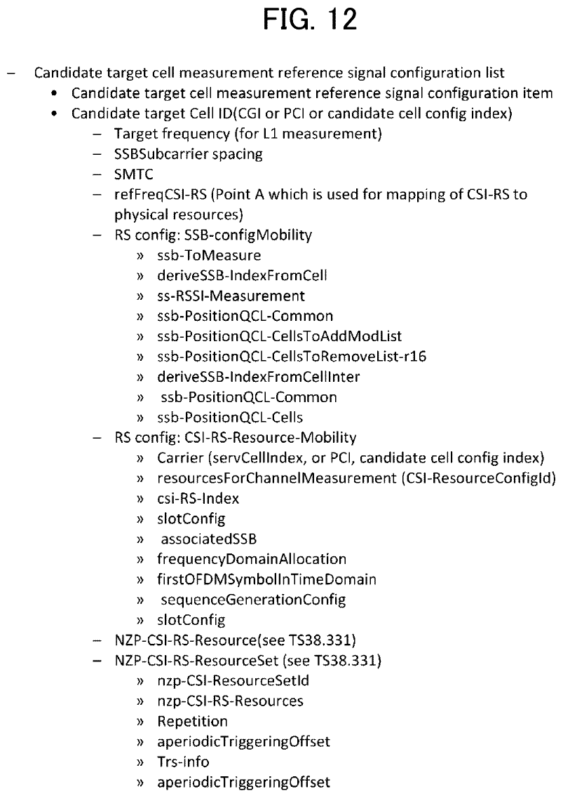

FIG. 12 illustrates an example configuration of L1 measurement RS config. As illustrated in FIG. 12, CGI, PCI, or candidate cell config index may be applied as a Candidate target Cell ID.

### (3.2) Operation Example 2

In Intra-CU/Inter-DU LTM, a source-side DU configures L1 measurement report config. In contrast, a target-side DU configures L1 measurement RS config. Thus, it is necessary to combine both configurations and provide that to the UE 200.

In this operation example, in Intra-CU/Inter-DU LTM, the CU and the DU cooperate to provide the UE 200 with the combined L1 measurement report config and L1 measurement RS config.

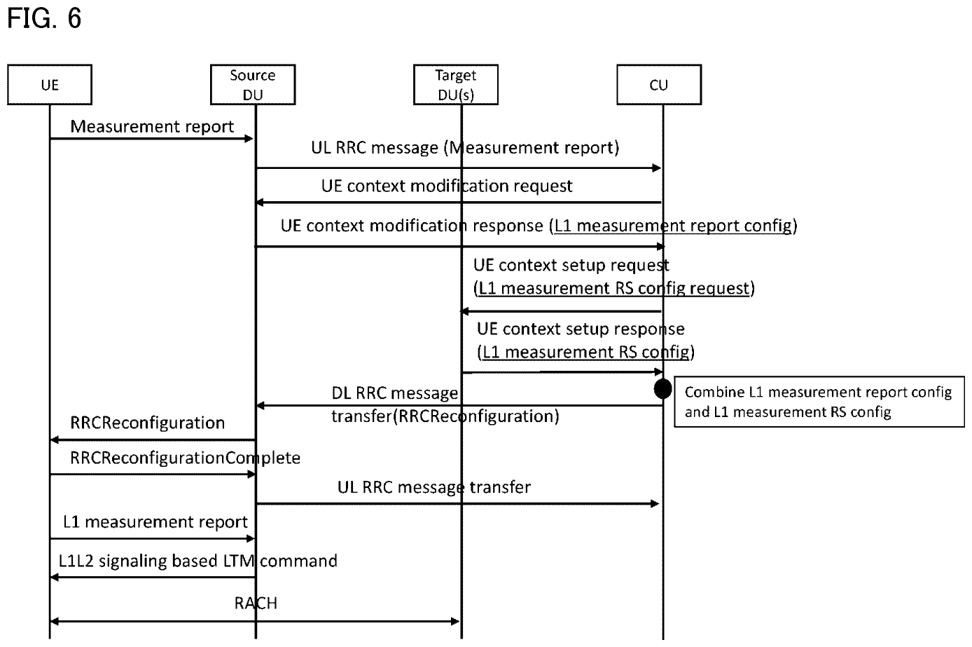

FIG. 6 illustrates a sequence example of L1/L2 Mobility according to operation example 2 (option 1). As illustrated in FIG. 6, a source-side DU may transmit L1 measurement report config to a CU by using a UE context modification response.

A target-side DU may transmit L1 measurement RS config to the CU by using a UE context setup response.

The CU may combine the received L1 measurement report config and L1 measurement RS config, and transmit RRCReconfiguration including the combined L1 measurement report config and L1 measurement RS config, to the source-side DU by using DL RRC message transfer. The source-side DU may transmit the RRCReconfiguration to the UE 200.

Note that combining the L1 measurement report config and the L1 measurement RS config may simply mean combining both configurations, or may mean integrating a part (or all) of the configurations, such as integrating and organizing a common part.

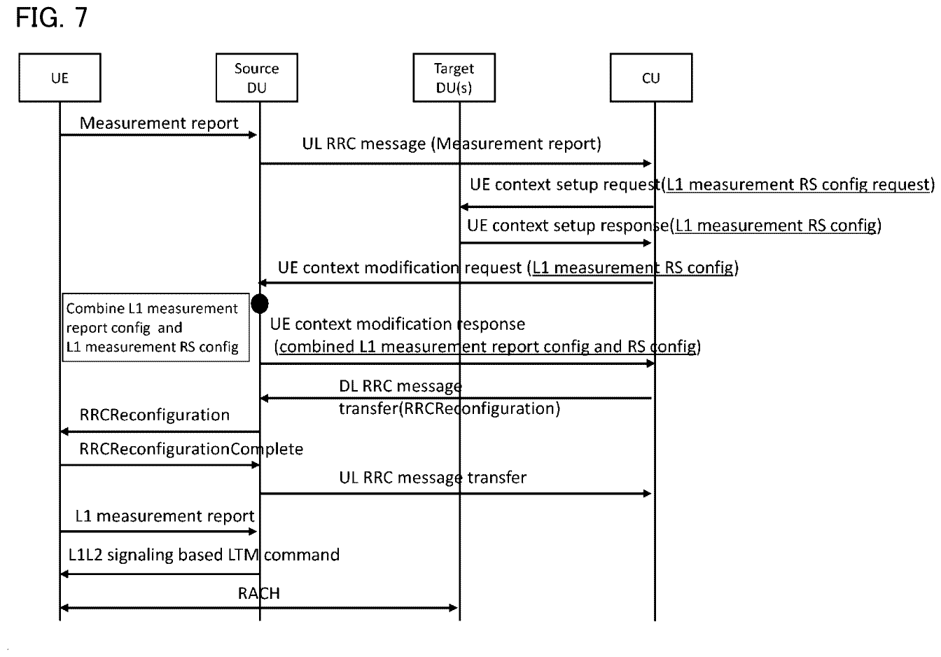

FIG. 7 illustrates an example sequence of L1/L2 Mobility according to operation example 2 (option 2). As illustrated in FIG. 7, a target-side DU may use a UE context setup response to transmit L1 measurement RS config to a CU.

The CU may transmit the received L1 measurement RS config to a source-side DU by using a UE context modification request.

The source-side DU may combine the L1 measurement report config and the L1 measurement RS config, and transmit to the CU a UE context modification response including the combined L1 measurement report config and L1 measurement RS config.

The CU may transmit the RRCReconfiguration including the combined L1 measurement report config and L1 measurement RS config to the source-side DU by using DL RRC message transfer. The source-side DU may transmit the RRCReconfiguration to the UE 200.

Note that the source-side DU need not transmit the UE context modification response including the L1 measurement report config and the L1 measurement RS config, and the CU need not transmit the RRCReconfiguration including the combined L1 measurement report config and L1 measurement RS config, but the source-side DU may directly transmit the RRCReconfiguration including the L1 measurement report config and the L1 measurement RS config.

The source-side DU may provide an interface directly between the source-side DU and the target-side DU. The source-side DU may acquire L1 measurement RS config directly from the target-side DU via the interface, combine it with L1 measurement report config, and configure it in the UE 200, or may transmit it to the CU, where it is then transmitted to the UE by using RRCReconfiguration.

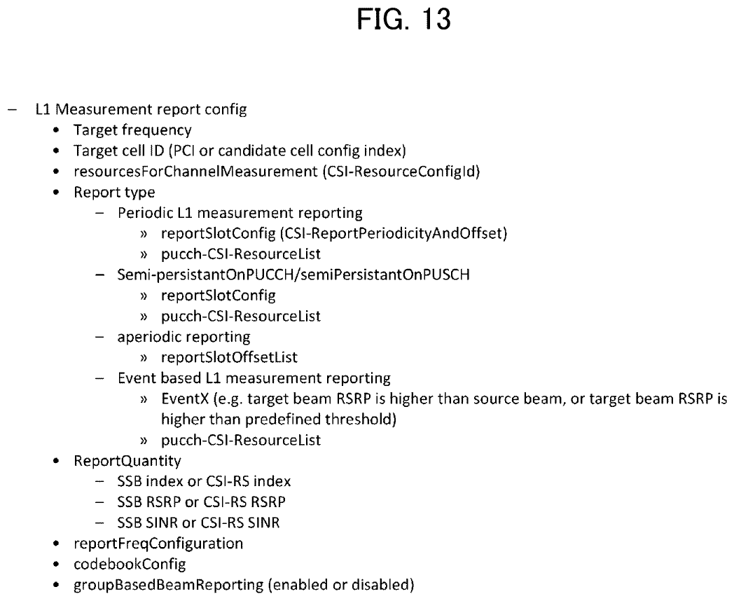

FIG. 13 illustrates an example configuration of L1 measurement report config. As illustrated in FIG. 13, CGI, PCI, or a candidate cell config index may be applied as a Target Cell ID. ReportQuantity may include a SINR of a synchronization signal block (SSB (SS (Synchronization Signal)/PBCH (Physical Broadcast Channel) Block) ), or CSI-RS.

### (3.3) Operation Example 3

In Inter-CU LTM, it is required that TCI state and L1 measurement RS config of a target-side DU be provided to a source-side DU, and that the source-side DU perform configuration for the UE 200, based on the TCI state and L1 measurement RS config of the target-side DU.

In this operation example, in Inter-CU LTM, the CU and the DU cooperate to provide the UE 200 with combined L1 measurement report config and L1 measurement RS config.

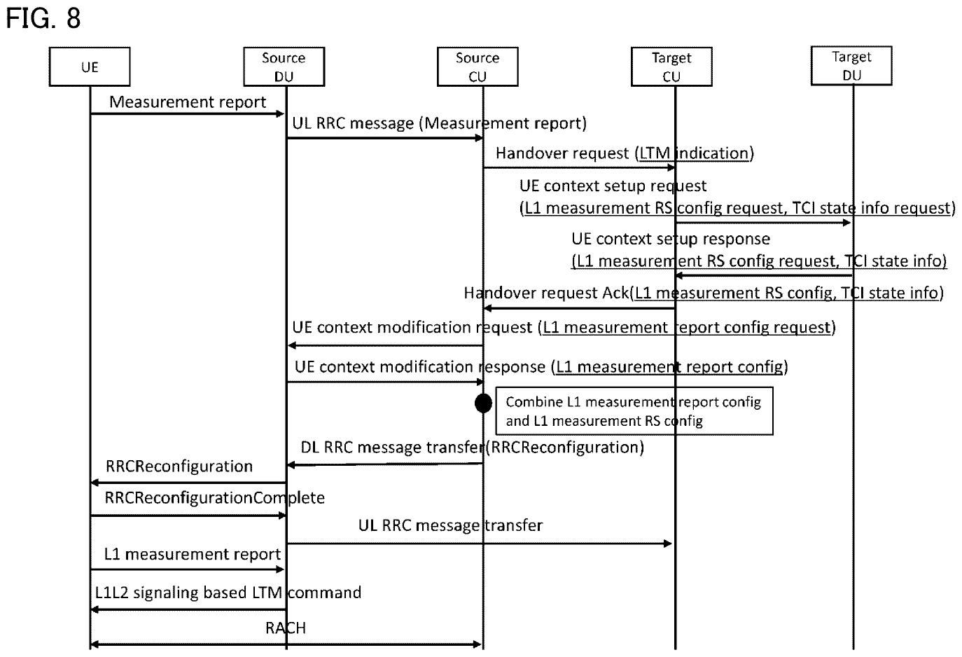

FIG. 8 illustrates an example sequence of L1/L2 Mobility according to operation example 3 (option 1). As illustrated in FIG. 8, when a source-side DU transmits a handover request to a target-side CU via an Xn interface, an explicit request for an LTM indication, or an explicit request for L1 measurement RS config and TCI state may be included.

The target-side CU may request L1 measurement RS config and TCI state to the target-side DU by using a UE context setup request.

The target-side DU may return the L1 measurement RS config and TCI state to the target-side CU by using a UE context setup response.

The target-side CU may transmit a handover request Ack including the L1 measurement RS config and TCI state to the source-side CU (alternatively, RRCReconfiguration msg. including the L1 measurement RS config and TCI state may be included as an RRC container in the handover request Ack).

The source-side CU may request L1 measurement report config from the source-side DU by using UE context modification request. The source DU may return L1 measurement report config to the source CU by using a UE context modification response.

The source-side CU may combine the L1 measurement report config and the L1 measurement RS config, and transmit RRCReconfiguration including the combined L1 measurement report config and L1 measurement RS config, and TCI state to the source-side DU by using DL RRC message transfer. The source-side DU may transmit the RRCReconfiguration to the UE 200.

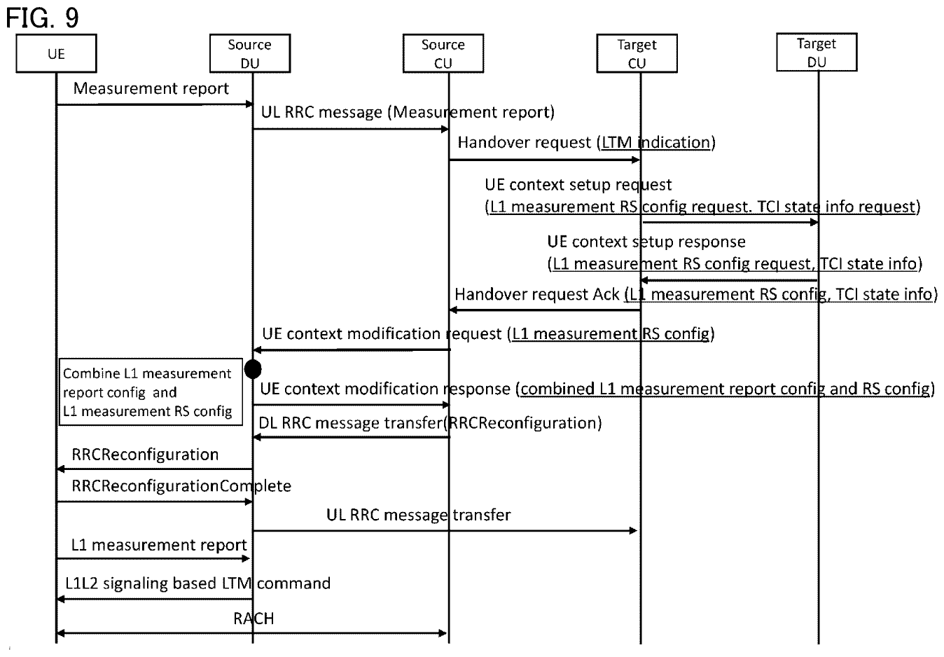

FIG. 9 illustrates an example sequence of L1/L2 Mobility according to operation example 3 (option 2). As illustrated in FIG. 9, steps until a target-side CU transmits a handover request Ack including L1 measurement RS config and TCI state to a source-side CU are the same as in option 1.

The source-side CU may transmit the L1 measurement RS config to the source-side DU by using a UE context modification request.

The source-side DU may combine the L1 measurement report config and the L1 measurement RS config, and transmit a UE context modification response including the combined L1 measurement report config and L1 measurement RS config to the source-side CU. The source-side CU may transmit the RRCReconfiguration including the combined L1 measurement report config and L1 measurement RS config, and TCI state, to the source-side DU by using DL RRC message transfer. The source-side DU may transmit the RRCReconfiguration to the UE 200.

### (3.4) Operation Example 4

The following options are assumed for layer 1 (L1) measurement report:
(Option 1): report to a serving DU
(Option 2) : report to a target-side DU candidate (candidate target DU)

In the case of option 2, a UL resource for measurement report, and a measurement result need to be linked between a CU and a DU.

In this operation example, when a measurement result of L1 measurement report is reported to a target-side DU candidate, the CU and the DU share a UL resource for measurement report and the measurement result and thus support an HO using L1/L2 mobility.

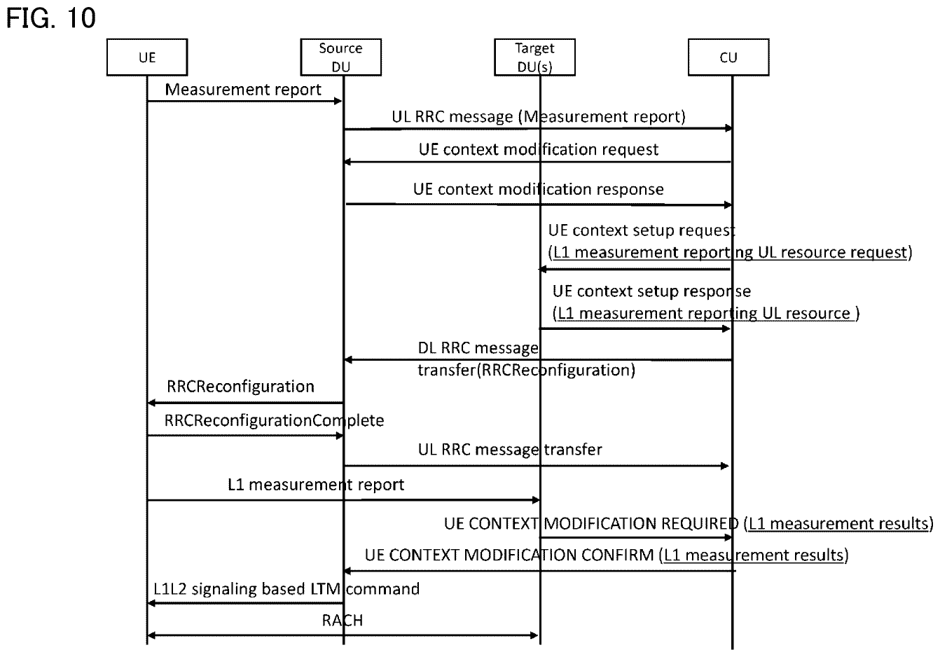

FIG. 10 illustrates an example sequence of L1/L2 Mobility according to operation example 4. As illustrated in FIG. 10, in Intra-CU/Inter-DU LTM, a CU may request L1 measurement reporting UL resource to a target-side DU by using a UE context setup request.

The target-side DU may report the L1 measurement reporting UL resource to the CU. The CU may transmit the L1 measurement reporting UL resource to a source-side DU, and the source-side DU may transmit the L1 measurement reporting UL resource to the UE 200.

After the UE 200 reports the L1 measurement report to the target-side DU, the target-side DU may transmit L1 measurement results to the CU by using UE CONTEXT MODIFICATION REQUIRED or a UL RRC message. The CU may transmit the L1 measurement results to the source-side DU by using UE CONTEXT MODIFICATION CONFIRM or a DL RRC message.

In the case of Inter-CU LTM, the source-side CU may request the L1 measurement reporting UL resource when transmitting a handover request to the target-side CU. The target-side CU may report a measurement reporting UL resource to the source-side CU by using a handover request ack. Here, a source-side gNB and a target-side gNB may exchange L1 measurement results via an Xn interface.

### (4) Actions and Effects

According to the above-described embodiment, the following actions and effects can be obtained. Specifically, the gNB 100 (CU and DU) can acquire TCI state, L1 measurement report config, and L1 measurement RS config in Intra-CU/Inter-DU LTM or Inter-CU LTM, and can reliably and timely provide the UE 200 with a configuration necessary for a handover.

Furthermore, in Intra-CU/Inter-DU LTM or Inter-CU LTM, the gNB 100 (CU and DU) can share an uplink resource for Measurement report and a measurement result, and the UE 200 can perform a reliable handover.

That is, the gNB 100 can realize more reliable cell transition (beam transition) of the UE 200, which is applied with L1/L2 mobility (LTM).

### (5) Other Embodiments

The above-described embodiment is not limited to the description of the embodiment, and it is obvious to those skilled in the art that various modifications and improvements thereof are possible.

For example, in the above-described embodiment, the CU is called the first device, and the DU is called the second device, but in particular, the target-side CU may be called the second device. Alternatively, the source-side DU may be called the first device. In addition, the CU may be called a central device or the like, and the DU may be called a distributed device or the like.

In the above description, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably.

Similarly, terms such as common, shared, group-common, UE-common, and UE-shared may be read interchangeably.

The block diagram (FIGS. 3 and 4) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but the functions are by no means limited to these. For example, a functional block (component) to implement a function of transmission may be referred to as a “transmitting section (transmitting unit),” a “transmitter”. The method for implementing each component is not particularly limited as described above.

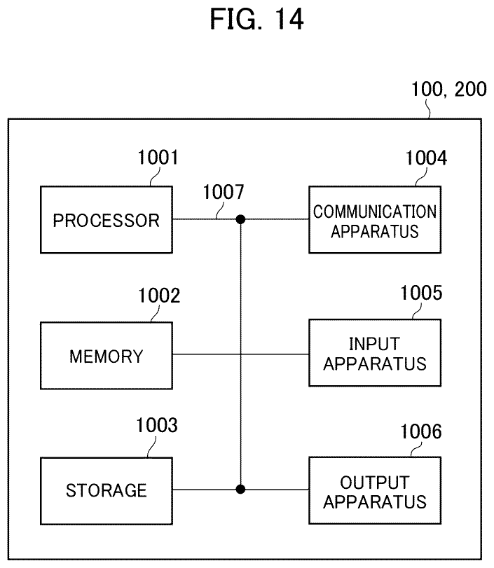

Furthermore, the above-described gNB 100 and UE 200 (the apparatus) may function as a computer that executes the processes of the radio communication method of the present disclosure. FIG. 14 is a diagram to show an example of a hardware structure of the apparatus. As shown in FIG. 14, the apparatus may each be formed as a computer apparatus that includes a processor 1001, a memory 1002, a storage 1003, a communication apparatus 1004, an input apparatus 1005, an output apparatus 1006, a bus 1007, and so on.

Note that in the following description, the word such as an apparatus can be read as a circuit, a device, a section, a unit, and so on. The hardware structure of the apparatus may be configured to include one or more of apparatuses shown in the drawings, or may be configured not to include part of apparatuses.

Each function of the apparatus (see FIGS. 3 and 4) is implemented by one of hardware elements or the combination of the hardware elements in the computer apparatus.

Each function of the apparatus is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The above-described various processes may be performed by a single processor 1001, or may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), and so on. The memory 1002 may be referred to as a “register,” a “cache,” a “main memory (primary storage apparatus)” and so on. The memory 1002 can store executable programs (program codes), software modules, and the like for implementing the method according to one embodiment of the present disclosure.

The storage 1003 is a computer-readable recording medium, and may be constituted with, for example, at least one of a compact disc (Compact Disc ROM (CD-ROM) and so on), a hard disk drive, a flexible disk, a magneto-optical disk (for example, a compact disc, a digital versatile disc, a Blu-ray (registered trademark) disk), a smart card, a flash memory device (for example, a card, a stick, and a key drive), a floppy (registered trademark) disk, a magnetic stripe, and so on. The storage 1003 may be referred to as “auxiliary storage apparatus.” The above recording medium may be a database including at least one of the memory 1002 and the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that performs output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, pieces of apparatus, including the processor 1001, the memory 1002, and others, are connected by a bus 1007 for communicating information. The bus 1007 may be formed with a single bus, or may be formed with buses that vary between pieces of apparatus.

Also, the apparatus may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information may be implemented by using physical layer signaling (for example, downlink control information (DCI), uplink control information (UCI)), higher layer signaling (for example, RRC signaling, Medium Access Control (MAC) signaling), broadcast information (master information block (MIB), system information block (SIB)), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New Radio (NR), New radio access (NX), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate systems, next-generation systems that are enhanced based on these. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Specific operations which have been described in the present disclosure to be performed by a base station may, in some cases, be performed by an upper node thereof. In a network including one or a plurality of network nodes with the base station, it is clear that various operations that are performed to communicate with a terminal can be performed by the base station and other network nodes (for example, Mobility Management Entities (MMEs), Serving-Gateways (S-GWs), and so on may be possible, but these are not limiting) other than the base station, or combinations of these. According to the above, a case is described in which there is a single network node other than the base station. However, a combination of multiple other network nodes may be considered (e.g., MME and S-GW).

The information or signals may be output from a higher layer (or lower layer) to a lower layer (or higher layer).

The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A determination may be realized by a value (0 or 1) represented by one bit, by a boolean value (true or false), or by comparison of numerical values (e.g., comparison with a predetermined value).

Each aspect/embodiment described in the present disclosure may be used independently, may be used in combination, or may be used by switching according to operations. Further, notification of predetermined information (e.g., notification of “X”) is not limited to an explicit notification, and may be performed by an implicit notification (e.g., by not performing notification of the predetermined information).

Software should be broadly interpreted to mean, regardless of whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) and wireless technologies (infrared, microwave, etc.), at least one of these wired line technologies or wireless technologies is included within the definition of the transmission medium.

Information, a signal, or the like, described in the present disclosure may be represented by using any one of various different technologies. For example, data, an instruction, a command, information, a signal, a bit, a symbol, a chip, or the like, referred to throughout the above description, may be represented by a voltage, an electric current, electromagnetic waves, magnetic fields, a magnetic particle, optical fields, a photon, or a combination thereof.

It should be noted that a term described in the present disclosure and/or a term required for understanding of the present disclosure may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNodeB (eNB),” a “gNodeB (gNB),” an “access point,” a “transmission point,” a “reception point,” a “transmission/reception point,” a “cell,” a “sector,” a “cell group,” a “carrier,” a “component carrier,” and so on can be used interchangeably. A base station may be referred to as the terms such as a “macro cell,” a “small cell,” a “femto cell,” a “pico cell,” and so on.

A base station can accommodate one or a plurality of (for example, three) cells (which may be referred to as sectors). When a base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a base station and a base station subsystem that provides communication services within this coverage.

In the present disclosure, transmitting information to the terminal by the base station may be referred to as instructing the terminal to perform any control and/or operation based on the information by the base station.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases by the skilled person in the art.

At least one of a base station and a mobile station may be referred to as a “transmitting apparatus,” a “receiving apparatus,” a “communication apparatus,” and so on. Note that at least one of a base station and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, a base station in the present disclosure may be interpreted as a mobile station (user terminal, hereinafter the same). For example, each aspect/embodiment of the present disclosure may be applied to the structure that replaces a communication between a base station and a mobile station with a communication between a plurality of mobile stations (for example, which may be referred to as “Device-to-Device (D2D),” “Vehicle-to-Everything (V2X),” and the like). In this case, the mobile station may have the functions of the base station described above. The words such as “uplink” and “downlink” may be interpreted as the words corresponding to the terminal-to-terminal communication (for example, “sidelink”). For example, an uplink channel, a downlink channel and so on may be interpreted as a sidelink channel (or sidelink).

Likewise, a mobile station in the present disclosure may be interpreted as a base station. In this case, the base station may have the functions of the mobile station described above.

A radio frame may be constituted of one or a plurality of frames in the time domain. Each of one or a plurality of frames may be referred to as a “subframe” in the time domain. Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology. A slot may include a plurality of mini-slots. Each mini-slot may be constituted of one or a plurality of symbols in the time domain. A mini-slot may be referred to as a “sub-slot.” A mini-slot may be constituted of the number of symbols less than a slot. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI,” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIS (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot, ” a “sub-slot, ” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)), ” a “sub-carrier group (SCG),” a “resource element group (REG),” a “PRB pair,” an “RB pair” and so on.

Furthermore, a resource block may be constituted of one or a plurality of resource elements (REs). For example, one RE may be a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of one or more wires, cables, and printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot”, depending on which standard is applied.

The phrase “based on” as used in the present disclosure does not mean “based only on”, unless otherwise specified.

In other words, the phrase “based on” means both “based only on” and “based at least on”.

“Means” included in the configuration of each of the above apparatuses may be replaced by “parts”, “circuits”, “devices”, etc.

Reference to elements with designations such as “first,” “second,” and so on used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present disclosure is not intended to be an “exclusive or”.

In the present disclosure, in the case where an article is added by translation, for example “a”, “an”, and “the”, the disclosure may include that the noun following these articles is plural.

As used in the present disclosure, the term “determining” may encompasses a wide variety of actions. For example, “determining” may be regarded as determining to have performed judging, calculating, computing, processing, deriving, investigating, looking up (looking up, search, inquiry) (e.g., looking up in a table, a database or another data structure), ascertaining and the like. Also, “determining” may be regarded as determining to have performed receiving (e.g., receiving information), transmitting (e.g., transmitting information), inputting, outputting, accessing (e.g., accessing data in a memory) and the like. Also, “determining” may be regarded as determining to have performed resolving, selecting, choosing, establishing, comparing and the like. That is, “determining” may be regarded as determining to have performed some action. Moreover, “determining” may be read as “assuming”, “expecting”, “considering”, and the like.

In this disclosure, the term “A and B are different” may mean “A and B are different from each other.” It should be noted that the term “A and B are different” may mean “A and B are different from C.” Terms such as “separated” or “combined” may be interpreted in the same way as the “different”.

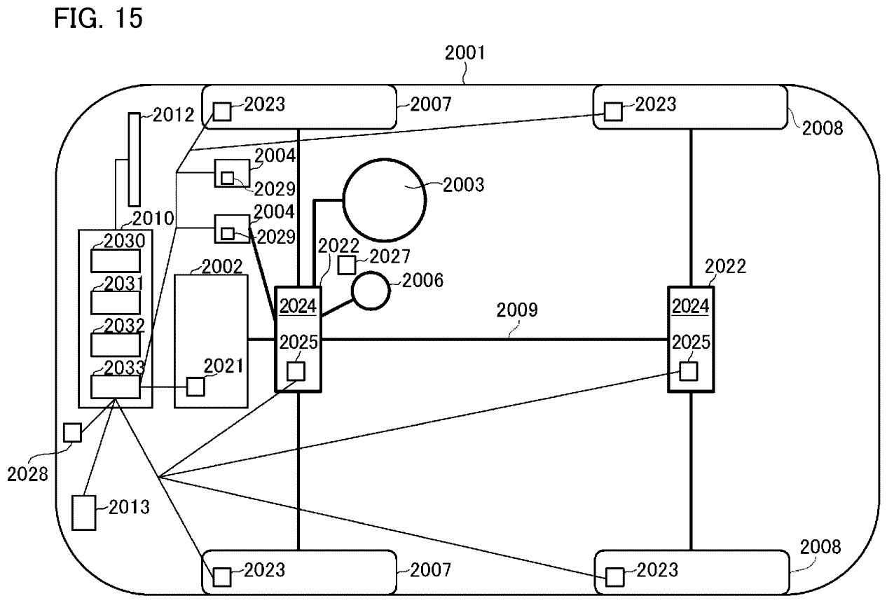

FIG. 15 shows an example of a configuration of a vehicle 2001. As shown in FIG. 15, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021-2029, an information service unit 2012, and a communication module 2013.

The drive unit 2002 may include, for example, an engine, a motor, and a hybrid of an engine and a motor. The steering unit 2003 includes at least a steering wheel and is configured to steer at least one of the front wheel or the rear wheel, based on the operation of the steering wheel operated by the user. The electronic control unit 2010 includes a microprocessor 2031, a memory (ROM, RAM) 2032, and a communication port (10 port) 2033. The electronic control unit 2010 receives signals from the various sensors 2021-29 provided in the vehicle. The electronic control unit 2010 may be referred to as an ECU (Electronic Control Unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUS controlling these devices. The information service unit 2012 provides various types of multimedia information and multimedia services to the occupants of the vehicle 2001 by using information obtained from the external device through the communication module 2013 or the like.

The information service unit 2012 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc. ), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and the sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 may transmit at least one of signals from the various sensors 2021 to 2028 described above input to the electronic control unit 2010, information obtained based on the signals, and information based on an input from the outside (a user) obtained via the information service unit 2012, to the external apparatus via radio communication. The electronic control unit 2010, the various Sensors 2021 to 2028, the information service unit 2012, and the like may be referred to as input units that receive input. For example, the PUSCH transmitted by the communication module 2013 may include information based on the input.

The communication module 2013 receives various types of information (traffic information, signal information, inter-vehicle information, etc.) transmitted from the external devices and displays the received information on the information service unit 2012 provided in the vehicle 2001. The information service unit 2012 may be referred to as an output unit that outputs information (for example, outputs information to devices, such as a display and a speaker, based on the PDSCH received by the communication module 2013 (or data/information decoded from the PDSCH)). In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

As described above, the present disclosure has been described in detail. It is apparent to a person skilled in the art that the present disclosure is not limited to one or more embodiments described in the present disclosure. The present disclosure can be implemented as modifications and variations without departing from the subject matter and the scope of the present disclosure defined by the descriptions of claims. Therefore, the descriptions of the present disclosure are for illustrative purposes only, and are not intended to be any limitations to the present disclosure.

### REFERENCE SIGNS LIST

10 Radio communication system
20 NG-RAN
100 gNB
110 Radio communication unit
120 Handover processing unit
130 Measurement configurating unit
140 Control unit
200 UE
210 Radio communication unit
220 Measurement reporting unit
230 Handover performing unit
240 Control unit
1001 Processor
1002 Memory
1003 Storage
1004 Communication apparatus
1005 Input apparatus
1006 Output apparatus
1007 Bus
2001 Vehicle
2002 Drive unit
2003 Steering unit
2004 Accelerator pedal
2005 Brake pedal
2006 Shift lever
2007 Left and right front wheels
2008 Left and right rear wheels
2009 Axle
2010 Electronic control unit
2012 Information service unit
2013 Communication module
2021 Current sensor
2022 Rotational speed sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port

1. A radio base station comprising:
a first device; and a second device, wherein
the first device includes:
a reception unit that receives, from the second device, a transmission configuration indication of the second device; and
a control unit that performs control in such a manner that the transmission configuration indication is transmitted to a terminal via the second device.

2. A radio base station comprising:
a first device; and a second device, wherein
the first device includes:
a reception unit that receives, from the second device, a reference signal configuration for measurement of the second device; and
a control unit that performs control in such a manner that the reference signal configuration is transmitted to a terminal via the second device.

3. A radio base station comprising:
a first device; and a second device, wherein
the first device includes:
a reception unit that receives a measurement report configuration of the second device on a source side, and a reference signal configuration for measurement of the second device on a target side; and
a control unit that combines the measurement report configuration and the reference signal configuration and performs control in such a manner that the combined measurement report configuration and reference signal configuration is transmitted to a terminal via the second device on the source side.

4. A radio base station comprising:
a first device; and a second device, wherein
the second device on a source side includes:
a reception unit that receives a reference signal configuration of the second device on a target side via the first device; and
a control unit that combines a measurement report configuration of the second device on the source side, and the received reference signal configuration, and performs control in such a manner that the combined measurement report configuration and reference signal configuration are transmitted to a terminal via the first device.

5. A radio communication method for a radio base station including a first device and a second device, the method comprising:
a step of receiving by the first device, from the second device, a transmission configuration indication of the second device; and
a step of performing control by the first device in such a manner that the transmission configuration indication is transmitted to a terminal via the second device.

6. A radio communication method for a radio base station including a first device and a second device, the method comprising:
a step of receiving by the first device, from the second device, a reference signal configuration for measurement of the second device; and
a step of performing control by the first device in such a manner that the reference signal configuration is transmitted to a terminal via the second device.
